(19) United States
(12) Patent Application Publication
(10) Pub. No.: US 2025/0252421 A1
(43) Pub. Date: Aug. 7, 2025

(54) SYSTEMS AND METHODS FOR AUTHORIZING ACCOUNT-SPECIFIC TRANSACTION REQUESTS

(71) Applicant: Wells Fargo Bank, N.A., San Francisco, CA (US)

(72) Inventors: Ramsay Huntley, San Francisco, CA (US); Timothy Craig Seagren, San Francisco, CA (US); Judson Murchie, San Francisco, CA (US)

(73) Assignee: Wells Fargo Bank, N.A., San Francisco, CA (US)

(21) Appl. No.: 18/430,448

(22) Filed: Feb. 1, 2024

(51) Int. Cl. G06Q 20/22; G06Q 20/12; G06Q 20/38; G06Q 20/40; G06Q 30/0207

(52) U.S. Cl. CPC G06Q 20/227; G06Q 20/387; G06Q 20/40; G06Q 30/0215; G06Q 20/12

(57) ABSTRACT

A system includes a processing circuit configured to receive a request associated with an offer. The processing circuit is further configured to determine a category of the offer. The processing circuit is further configured to model the category with the offer to generate a first amount corresponding to a first transaction instrument and a second amount corresponding to a second transaction instrument for the offer. The processing circuit is further configured to generate and provide an interface corresponding to the first amount and the second amount. The processing circuit is further configured to receive a transaction request corresponding to the first transaction instrument or the second transaction instrument. The processing circuit is further configured to authorize the transaction request for either the first amount or the second amount based on the transaction request corresponding to the first transaction instrument or the second transaction instrument.

### TECHNICAL FIELD

The present disclosure relates generally to the field of transaction authorization, including displaying amounts corresponding to transaction instruments for an offer and authorizing account-specific transaction requests.

### BACKGROUND

People typically have difficulty determining how to maximize their purchasing power due to the sheer number of payment instruments available to the typical consumer.

### SUMMARY

Some arrangements relate to a system. In some arrangements, the system includes a processing circuit. In some arrangements, the processing circuit includes memory and one or more processors. In some arrangements, the processing circuit is configured to receive a request associated with an offer from a graphical user interface (GUI) presented on a user device. In some arrangements, the processing circuit is also configured to determine a category of the offer. In some arrangements, the processing circuit is also configured to model the category with the offer to generate a first amount and a second amount for the offer. In some arrangements, the first amount corresponds to a first transaction instrument and the second amount corresponds to a second transaction instrument. In some arrangements, the processing circuit is also configured to generate and provide an interface corresponding to the first amount and the second amount to the GUI of the user device. In some arrangements, the interface includes an actionable element and content associated with the offer. In some arrangements, the processing circuit is also configured to receive a transaction request corresponding to at least one of the first transaction instrument or the second transaction instrument from a merchant computing system. In some arrangements, the transaction request includes transaction information of the offer. In some arrangements, the processing circuit is also configured to authorize the transaction request for either the first amount or the second amount based on the transaction request corresponding to at least one of the first transaction instrument or the second transaction instrument.

Some arrangements relate to a method. In some arrangements, the method includes receiving, from a graphical user interface (GUI) presented on a user device, a request associated with an offer. In some arrangements, the method also includes determining a category of the offer. In some arrangements, the method also includes modeling the category with the offer to generate a first amount and a second amount for the offer. In some arrangements, the first amount corresponds to a first transaction instrument and the second amount corresponds to a second transaction instrument. In some arrangements, the method also includes generating and providing, to the GUI of the user device, an interface corresponding to the first amount and the second amount. In some arrangements, the interface includes an actionable element and content associated with the offer. In some arrangements, the method also includes receiving, from a merchant computing system, a transaction request corresponding to at least one of the first transaction instrument or the second transaction instrument. In some arrangements, the transaction request includes transaction information of the offer. In some arrangements, the method also includes authorizing the transaction request for either the first amount or the second amount based on the transaction request corresponding to at least one of the first transaction instrument or the second transaction instrument.

Some arrangements relate to a computer-readable storage medium (CRM) having instructions stored thereon that, when executed by a processing circuit, cause the processing circuit to perform operations. In some arrangements, the operations include receiving, from a graphical user interface (GUI) presented on a user device, a request associated with an offer. In some arrangements, the operations also include determining a category of the offer. In some arrangements, the operations also include modeling the category with the offer to generate a first amount and a second amount for the offer. In some arrangements, the first amount corresponds to a first transaction instrument and the second amount corresponds to a second transaction instrument. In some arrangements, the interface includes an actionable element and content associated with the offer. In some arrangements, the operations also include receiving, from a merchant computing system, a transaction request corresponding to at least one of the first transaction instrument or the second transaction instrument. In some arrangements, the transaction request includes transaction information of the offer. In some arrangements, the operations also include authorizing the transaction request for either the first amount or the second amount based on the transaction request corresponding to at least one of the first transaction instrument or the second transaction instrument.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a transaction architecture including a transaction system, according to example embodiments.

FIG. 2 is a block diagram illustrating an example computing system suitable for use in the example embodiments described herein.

FIG. 3 is a flow diagram of a method for authorizing transaction requests, according to example embodiments.

FIG. 4A is an illustration of a configuration of a user interface generated by the transaction system of FIG. 1, according to example embodiments.

FIG. 4B is an illustration of an additional configuration of a user interface generated by the transaction system of FIG. 1, according to example embodiments.

FIG. 4C is an illustration of an additional configuration of a user interface generated by the transaction system of FIG. 1, according to example embodiments.

FIG. 4D is an illustration of an additional configuration of a user interface generated by the transaction system of FIG. 1, according to example embodiments.

FIG. 4E is an illustration of an additional configuration of a user interface generated by the transaction system of FIG. 1, according to example embodiments.

FIG. 4F is an illustration of an additional configuration of a user interface generated by the transaction system of FIG. 1, according to example embodiments.

FIG. 4G is an illustration of an additional configuration of a user interface generated by the transaction system of FIG. 1, according to example embodiments.

### DETAILED DESCRIPTION

Referring generally to the figures, the systems and methods described herein relate to determining amounts corresponding to transaction instruments that may be used to make a purchase associated with an offer. These amounts may be modeled by determining a category for the offer and then modeling the category with the offer to generate the amounts corresponding to the transaction instruments. Through this process, the systems and methods disclosed herein enable users to receive more than one amount corresponding to more than one transaction instrument that may be used to make a purchase associated with the offer. Furthermore, the systems and methods may provide an interface corresponding to the amounts for the users to allow for visualization of the more than one amounts. The systems and methods disclosed herein may also receive and authorize a transaction request for the offer corresponding to the more than one amounts and the more than one transaction offers.

In typical systems and methods, a computer device (e.g., desktop computer, mobile device, smart device) can present a single amount corresponding to one or more transaction instruments that may be used to make a purchase associated with an offer. However, given that there may be other amounts corresponding to transaction instruments that vary from the single amount corresponding to the one or more transaction instruments, the typical systems and methods may result in a user not being aware of an amount for the offer that is lower than the single amount, which may result in the user exchanging a higher amount than required for the offer and resulting in a higher loss to the assets of the user. The systems and methods described herein address this issue, providing the user with multiple amounts corresponding to more than one transaction instruments that the user may use to make a purchase associated with an offer, such that the user may select an optimal amount corresponding to one of the transaction instruments to make the purchase associated with the offer.

In some arrangements, the systems and methods disclosed herein are configured to notify a user of differences between exchanging different amounts corresponding to different transaction instruments for an offer. This is accomplished through identifying a variation between exchanging the different amounts corresponding to the different transaction instruments for the offer and then modeling the variation to generate a value offset between the different amounts. The value offset can then be displayed to the user such that the user may visualize the differences between exchanging the different amounts corresponding to the different transaction instruments for the offer. Therefore, the systems and methods disclosed herein provide an improvement to existing systems and methods by providing users with visualizations of the differences between exchanging the different amounts corresponding to the different transaction instruments for the offer such that the users may visualize the differences and make informed transaction decisions for the offer.

In terms of transaction validation, the systems and methods disclosed herein are configured to validate that an amount in a transaction request for an offer corresponds to a transaction instrument that corresponds to the amount prior to authorizing the transaction request. Accordingly, the systems and methods ensure that the amount from the transaction instrument is correct prior to authorizing the transaction request in a scenario where different amounts corresponding to different transaction requests exist. Furthermore, the present disclosure simplifies the transaction process for the user by providing additional information associated with the offer, which can be difficult for the user to discover or take the user additional time to discover if not provided.

Accordingly, the present disclosure is directed to systems and methods for improving transaction experiences, transaction validation, and transaction interface usability. It achieves this by implementing modeling and validation to generate transaction data and confirm that a transaction request is correct before authorizing the transaction request. This approach allows for a user to receive additional information relating to purchases associated with offers prior to initiating the purchases while reducing errors related to the purchases once the purchases have been initiated. Furthermore, the system and methods visually display data to ensure a high level of usability, allowing for users to more easily make informed decisions. Thus, the systems and methods described herein provide a benefit over current systems.

As used herein, “offer” refers to a proposal for a sale of a good, a service, or other element to a person that the person may acquire by exchanging an amount for the good, the service, or other element. That is, an offer is an opportunity for a person to purchase a product by paying a price for the offer. In some embodiments, an offer can be associated with furniture, jewelry, electronics, automotive, or other goods. In some embodiments, an offer can be associated with personal training, financial services, transportation, or other services.

As used herein, “category” refers to a narrow or broad grouping of an offer. That is, a category may group together one or more of the offers using a profile of the offers. In some embodiments, a category can include the offers that are specific to a vendor, the offers that are specific to a type of item, the offers that are specific to a location or region, the offers that are specific to a transaction instrument, or other distinctions. In some embodiments, the category may include the offers that are specific to a certain activity. For example, the category can include the offers that are specific to activities that increase the energy efficiency of a home. In some embodiments, the category may only exist for a specific time frame. For example, a holiday category for the offers may only exist around a holiday season. In some embodiments, the category may be formed through a partnership between a vendor and an institution associated with a transaction instrument such that the offers belong to the category when a transaction is made for the offers using the transaction instrument. For example, a financial institution associated with a credit card can form a partnership with a vendor such that all of the offers from the vendor belong to a category that is also associated with the credit card of the financial institution. The category of the offers may be tracked through creating a list of the offers associated with each of the categories. The list may include certain of the offers that are approved for the category or may include merchant codes (e.g., vendor codes, etc.) associated with the offers that may be tracked during purchases associated with the offers. For example, a category may include a list of the offers that are qualified for certain discounts. In some embodiments, an offer may be included in multiple categories. For example, an offer may be included in a category related to a specific vendor and may also be included in a category related to receiving a tax rebate.

As used herein, “transaction instrument” refers to an instrument that can transfer an amount from a first entity to a second entity. That is, a transaction instrument may complete a transaction of an amount from a first account to a second account. In some embodiments, a transaction instrument can be a bank account, a credit card, cash, a home savings account, or other instruments that can transfer amounts of funds. For example, a checking account may hold an amount and then may transfer a portion or an entirety of the amount to a separate account or a different entity. In some embodiments, the transaction instrument may include incentives for being used to transfer an amount from a first entity to a second entity to make a purchase associated with an offer. For example, a credit card may include a bonus if the credit card is used to make a purchase associated with an offer. In some embodiments, the transaction instrument may only include incentives when used to make a purchase associated with an offer in a category. For example, a credit card may only include a bonus if the credit card is used to make a purchase associated with an offer in a travel category.

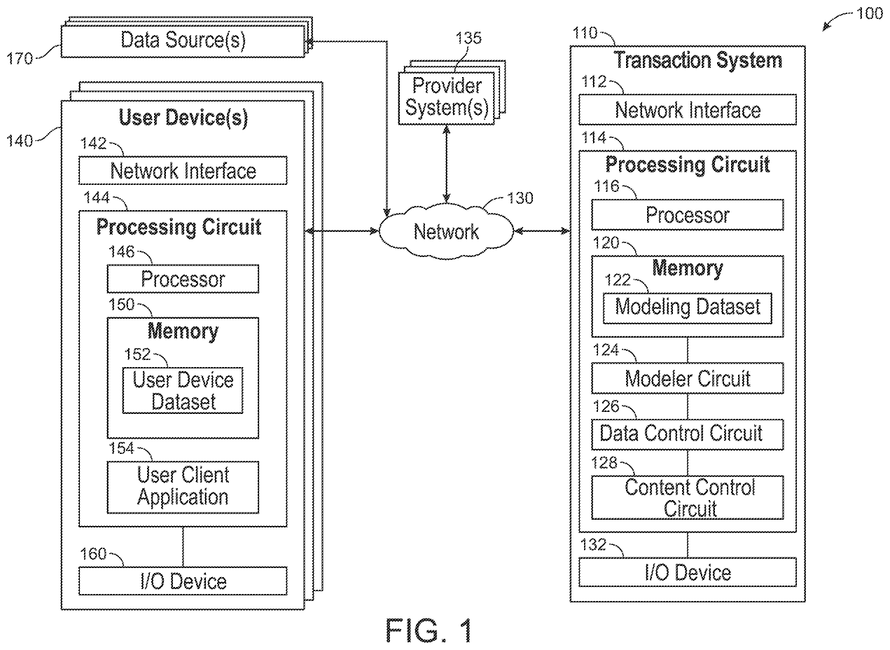

Referring to FIG. 1, a block diagram of a transaction modeler architecture 100 including a transaction system 110 is shown, according to some embodiments. The transaction system 110 can be associated with a provider, such as a service provider, an entity, a consultant, a retailer, a bank, or a financial institution (FI). The transaction modeler architecture 100 further includes one or more user devices (e.g., user device 140), one or more data sources (e.g., data source 170), and a transaction system 110 (e.g., a computing system of a location of the FI). In some embodiments, the transaction system 110, user device 140 (as well as any additional user devices), and data source 170 are communicatively coupled. In some embodiments, the components of the transaction modeler architecture 100 may be communicably and operatively coupled to each other over a network, such as network 130, that permits the direct or indirect exchange of data, values, instructions, messages, and the like (represented by the double-headed arrows in FIG. 1). The network 130 may include one or more of a cellular network, the Internet, Wi-Fi™, Wi-Max™, a proprietary provider network, a proprietary retail or service provider network, and/or any other kind of wireless or wired network.

Each system or device in transaction modeler architecture 100 may include one or more processors, memories, and network interfaces (sometimes referred to herein as a “network circuit”). The memory may store programming logic that, when executed by the processor, controls the operation of the corresponding computing system or device. The memory may also store data in databases. For example, memory 120 may store programming logic that when executed by processor 116 within processing circuit 114, causes an update in the modeling dataset 122 from a user's account with information received from a user device 140 and/or data sources 170. The various components of devices in transaction modeler architecture 100 may be implemented via hardware (e.g., circuitry), software (e.g., executable code), or any combination thereof. Devices and components in FIG. 1 can be added, deleted, integrated, separated, and/or rearranged in various embodiments of the disclosure.

The transaction system 110 may be operated by a provider. The transaction system 110 includes a network interface 112 and can be structured and used to establish connections with other computing systems and devices (e.g., the user devices 140, the data source 170, etc.) via the network 130. The network interface 112 includes program logic that facilitates connection of the transaction system 110 to the network 130. For example, the network interface 112 may include any combination of a wireless network transceiver (e.g., a cellular modem, a Bluetooth™ transceiver, a WiFi™ transceiver, etc.) and/or a wired network transceiver (e.g., an Ethernet transceiver). In some arrangements, the network interface 112 includes the hardware (e.g., processor, memory, and so on) and machine-readable media sufficient to support communication over multiple channels of data communication. Further, in some arrangements, the network interface 112 includes cryptography capabilities to establish a secure or relatively secure communication session in which data communicated over the session is encrypted. In various embodiments, the transaction modeler architecture 100 can adapt to network traffic needs by compressing content, by any computing device described herein, and sending it (e.g., via network 130) to various other computing devices, by adjusting security filters to remove junk traffic off network 130 (e.g., by monitoring packets), and so on. While described with regards to a provider, the transaction system 110 may be used in other scenarios.

The processing circuit 114 includes a processor 116, a memory 120, a modeler circuit 124, a data control circuit 126, and a content control circuit 128. In some embodiments, the processing circuit 114 may contain more or less components than are shown in FIG. 1. The components of FIG. 1 are meant for illustrative purposes only and should not be regarded as limiting in any manner. The memory 120 may be one or more devices (e.g., RAM, ROM, Flash memory, hard disk storage) for storing data and/or computer code for completing and/or facilitating the various processes described herein. The memory 120 may be or include non-transient volatile memory, non-volatile memory, and non-transitory computer storage media. Memory 120 may include database components, object code components, script components, or any other type of information structure for supporting the various activities and information structures described herein. Memory 120 may be communicably coupled to the processor 116 and include computer code or instructions for executing one or more processes described herein. The processor 116 may be implemented as one or more application specific integrated circuits (ASICs), field programmable gate arrays (FPGAs), a group of processing components, or other suitable electronic processing components. As such, the transaction system 110 is configured to run a variety of application programs and store associated data in a database of the memory 120 (e.g., modeling dataset 122). One such application may be to provide data to the modeler circuit 124, data control circuit 126, and content control circuit 128.

The processing circuit 114, interacting (e.g., communicating with by sending requests and/or commands/signals) with the memory 120 can store a variety of data in the modeling dataset 122, according to some embodiments, including category data structures. The modeler circuit 124 can use data stored in the modeling dataset 122 and other gathered data to generate a category data structure which can then be stored in the modeling dataset 122. The modeling dataset 122 may also be configured to store the category data structure which can include categories for offers associated with the transaction instruments of the provider (e.g., the FI). For example, the modeling dataset 122 can store category information that models offers associated with home ownership, such as building supplies, remodeling services, and other offers to certain transaction instruments. The modeling dataset can store other offer information used in modeling activity such as certain amounts for offers in categories that are associated with certain transaction instruments. In some embodiments, the modeling dataset 122 can include a token vault that stores an associated category token and/or offer token for each transaction instrument. The modeling dataset 122 may further be configured to store offer data for each offer, such as past transaction amounts, photographs or videos, reviews, descriptions, and so on.

In some embodiments, the memory 120 and modeling dataset 122 may be communicably coupled to the modeler circuit 124, data control circuit 126, or content control circuit 128. It should be understood that “circuit” used herein can be any processing circuit(s) or computational systems designed to perform specific tasks, including but not limited to microprocessors, microcontrollers, application-specific integrated circuits (ASICs), field-programmable gate arrays (FPGAs), or any combination thereof, capable of executing the required functions and operations for handling, analyzing, and processing the category data, offers, and actionable activities as described herein. The modeler circuit 124 can implement modeling operations of the transaction system 110. In various arrangements, the modeler circuit 124 can be configured to receive a plurality of data from a plurality of data sources (e.g., memory 120, modeling dataset 122, data control circuit 126, content control circuit 128, user device 140, data source 170) via one or more data channels (e.g., over network 130). Each data channel may include a network connection (e.g., wired, wireless, cloud) between the devices or systems and the transaction system 110. For example, the modeler circuit 124 can query the memory 120 for data of the modeling dataset 122 and use the modeling data to generate a category data structure that models offer data and one or more transaction instruments (e.g., the modeling dataset that includes amounts corresponding to certain transaction instruments for offers).

The modeler circuit 124 can be configured to determine a category of an offer and then model the category with the offer to generate a first amount and a second amount after receiving a request associated with the offer. In some embodiments, the first amount generated by the modeler circuit 124 corresponds to a first transaction instrument and the second amount generated by the modeler circuit 124 corresponds to a second transaction instrument. For example, the modeler circuit 124 may determine that an offer belongs in a category based on a list associated with the category. The modeler circuit 124 may then model the category with the offer to generate a first amount corresponding to a first transaction instrument and a second amount corresponding a second transaction instrument based on information of the offer and the relationship between the category and the first transaction instrument and the relationship between the category and the second transaction instrument. For example, the modeler circuit 124 may determine that electric vehicle accessories belong in an energy efficient category. The modeler circuit 124 may then model the energy efficient category with the electric vehicle accessories to generate a first purchase amount corresponding to a checking account and a second purchase amount corresponding to a credit card. Since the credit card includes cash back when the credit card is used to purchase energy efficient items within the energy efficient category, the second purchase amount is lower than the first purchase amount.

The modeler circuit 124 can be further configured to receive new requests associated with offers or updated categories from the input/output device 132 of the transaction system 110 or from the modeling dataset 122. For example, the modeler circuit 124 may be configured to continuously monitor and receive new information from a user device 140, data source 170, or provider system 135 via the network 130 and determine the effect on the one or more categories. New data can affect the modeling dataset 122 and thereon affect the processes carried out by the modeler circuit 124, data control circuit 126, content control circuit 128, and other parts of the transaction system 110. For example, an offer can be added to a new category after the transaction system 110 has already modeled the categories with the offer. A source (e.g., user device 140, data source 170, or provider system 135) may then send the category, (e.g., acceptable for home savings account) to the transaction system 110. Because category updates can be a significant factor affecting the amount corresponding to the transaction instrument, not only can the modeling dataset 122 be updated, but the modeler circuit 124 can update the category data structure. For example, the category update can cause the modeler circuit 124 to change the amount corresponding to the transaction instrument, which affects the amount the user may transaction for the offer.

In some embodiments, the modeler circuit 124 can identify that there is a change to the first amount or the second amount based on a change to a category and may communicate the change to the first amount or the second amount to the user device 140 (e.g., through the content control circuit 128, through the I/O device 132, etc.). The communication of the change to the first amount or the second amount may include a notification to the user device 140 that may notify the user of the change to the first amount or the second amount. For example, after a category has been updated to include an offer, the modeler circuit 124 can determine that an amount from a transaction instrument corresponding to that offer has decreased. The modeler circuit 124 can then notify a user through a notification to a user device that the amount from the transaction instrument corresponding to that offer has decreased, allowing for the user to take advantage of the decreased amount. For example, a category that provides discounts on items when purchased with a home savings account may be updated to include solar panels. The modeler circuit 124 can determine that a purchase amount for the solar panels has decreased when purchased with the home savings account and then notify the user of the decrease in the purchase amount.

In some embodiments, the modeler circuit 124 can be configured to determine more than one category of an offer and model the more than one category with the offer to generate amounts corresponding to transaction instruments. For example, an offer may be included in more than one category. The modeler circuit 124 can model the more than one category with the offer and generate amounts that correspond with transaction instruments that takes into account each of the categories of the offer, For example, a window replacement may be included in a vendor category that provides discounts on offers associated with a vendor when purchased with a home savings account and a rebate category associated with a government rebate program that provides rebates on offers that improve energy efficiency. The modeler circuit 124 can determine that the window replacement is included in each of the vendor category and the rebate category. The modeler circuit 124 can model the window replacement with the vendor category and the rebate category to generate a first purchase amount for the window replacement from a normal account (e.g., checking account, credit card account, etc.) that includes the rebate on offers that improve energy efficiency, but does not include the discount on offers associated with the vendor and a second purchase amount for the window replacement from the home savings account that includes both the rebate on offers that improve energy efficiency and the discount on offers associated with the vendor.

In some embodiments, the modeler circuit 124 can be configured to determine a category of more than one offer and then model the category with the more than one offer to generate amounts corresponding to transaction instruments. For example, more than one offer can be included in a request from a user device. The modeler circuit 124 can determine the category associated with each of the more than one offer. In some cases, each of the more than one offers may be collectively included in a category. In other cases, each of the more than one offers may each separately be included in more than one category. After determining the category associated with each of the more than one offer, the modeler circuit can then model the category or more than one category with the more than one offer and generate amounts that correspond with transaction instruments that take into account the category or more than one category of each of the more than one offer. For example, a request may include an appliance that is included in a bonus category that provides a bonus back to a purchaser on offers associated with a vendor when purchased with a home savings account and an appliance installation service that is not included in the bonus category. The modeler circuit 124 can determine that the appliance is included in the bonus category and the appliance installation service is not included in the bonus category. Then, the modeler circuit 124 can model the appliance and the appliance installation service with the bonus category to generate a first purchase amount for the appliance and the appliance installation service from a normal account that does not include the bonus and a second purchase amount for the appliance and the appliance installation service from the home savings account that includes the bonus.

In some embodiments, the modeler circuit 124 can be configured to determine a category of an offer and then model the category with the offer to generate a first amount, a second amount, and a third amount. In some embodiments, the first amount created by the modeler circuit 124 corresponds to a first transaction instrument, the second amount created by the modeler circuit 124 corresponds to a second transaction instrument, and the third amount created by the modeler circuit 124 corresponds to a third transaction instrument. For example, a user may have access to more than two (e.g., three, four, five, etc.) transaction instruments that are available to transaction amounts for offers. The modeler circuit 124 can model the category with the offer to generate an amount for each of the transaction instruments. For example, a user may have access to a checking account, a home savings account, and a vendor credit card and request information relating to a purchase amount of a desk. The modeler circuit 124 can model the desk with one or more categories to generate a first purchase amount corresponding to the checking account, a second purchase amount corresponding to the home savings account, and a third purchase amount corresponding to the vendor credit card. The user may then analyze any differences between the first purchase amount, the second purchase amount, and the third purchase amount before purchasing the desk with one of the checking account, the home savings account, or the vendor credit card.

In some embodiments, the modeler circuit 124 can authorize a transaction request received by the data control circuit 126 for an amount based on the transaction request corresponding to a transaction instrument. For example, after a user device has been provided with an interface including a first amount for an offer corresponding to a first transaction instrument and a second amount for an offer corresponding to a second transaction instrument, the user device may generate a transaction request through a merchant computing system. The transaction request includes information of the offer and corresponds to at the first transaction instrument or the second transaction instrument. The modeler circuit 124 can then authorize the transaction amount for either the first amount or the second amount based on the transaction request corresponding to the first transaction instrument or the second transaction instrument. In some embodiments, the transaction request may be received from a merchant computing system. For example, after receiving a first purchase amount for a HVAC system corresponding to a credit card and a second purchase amount for a HVAC system corresponding to a home savings account, a user may generate a purchase request through a website of a vendor of the HVAC system using either the credit card or the home savings account. The modeler circuit 124 can then authorize the purchase request from the website of the vendor for either the first purchase amount or the second purchase amount based on if the purchase request corresponds to the credit card or the home savings account.

In some embodiments, the modeler circuit 124 can configure a transaction request to correspond to an amount, validate that the amount is associated with a transaction instrument, and then adjust the amount to a different amount if the transaction request corresponds to the transaction instrument. For example, after the modeler circuit 124 has modeled a category and an offer to generate a first amount corresponding to a first transaction instrument and a second amount corresponding to a second transaction instrument and after receiving a transaction request from a merchant computing system, the modeler circuit 124 can configure the transaction request to correspond to the first amount by embedding the first amount in the transaction request. The modeler circuit 124 can then validate that the transaction request corresponds to the second transaction instrument and then adjust the transaction request to correspond to the second amount if the transaction request corresponds to the second transaction instrument. The modeler circuit 124 can adjust the transaction request by removing the first amount from the transaction request and embedding the second amount in the transaction request. For example, after the modeler circuit 124 has generated a first purchase amount corresponding to a checking account and a second purchase amount corresponding to a credit card for a computer and has received a purchase request for the computer from a vendor system, the modeler circuit 124 can add the first purchase amount for the computer to the purchase request. The modeler circuit 124 can then validate that the purchase request was made using the credit card. If the purchase request was made using the credit card, then the modeler circuit adjusts the purchase request to include the second purchase amount instead of the first purchase amount. If the purchase request was made using the checking account, then the modeler circuit 124 does not adjust the purchase request and the purchase request continues to include the first purchase amount.

In another example, after the modeler circuit 124 has modeled a category and an offer to generate a first amount corresponding to a first transaction instrument and a second amount corresponding to a second transaction instrument and after receiving a transaction request from a merchant computing system, the modeler circuit 124 can configure the transaction request to correspond to the second amount by embedding the second amount in the transaction request. The modeler circuit 124 can then validate that the transaction request corresponds to the first transaction instrument and then adjust the transaction request to correspond to the first amount if the transaction request corresponds to the first transaction instrument. The modeler circuit 124 can adjust the transaction request by removing the second amount from the transaction request and embedding the first amount in the transaction request. For example, after the modeler circuit 124 has generated a first purchase amount corresponding to a checking account and a second purchase amount corresponding to a credit card for a computer and has received a purchase request for the computer from a vendor system, the modeler circuit 124 can add the second purchase amount for the computer to the purchase request. The modeler circuit 124 can then validate that the purchase request was made using the checking account. If the purchase request was made using the checking account, then the modeler circuit adjusts the purchase request to include the first purchase amount instead of the second purchase amount. If the purchase request was made using the credit card, then the modeler circuit 124 does not adjust the purchase request and the purchase request continues to include the second purchase amount.

In some embodiments, the modeler circuit 124 can identify a variation between exchanging a first amount for an offer using a first transaction instrument and exchanging a second amount for the offer using a second transaction instrument and then model the variation to generate a value offset between the first amount and the second amount. For example, after the modeler circuit 124 has modeled a category and an offer to generate a first amount corresponding to a first transaction instrument and a second amount corresponding to a second transaction instrument, the modeler circuit 124 can identify a variation between exchanging the second amount with the second transaction instrument for the offer and exchanging the first amount with the first transaction instrument for the offer. The modeler circuit 124 can then model the variation between exchanging the second amount with the second transaction instrument for the offer and exchanging the first amount with the first transaction instrument for the offer to generate a value offset between the first amount and the second amount. For example, after the modeler circuit 124 has modeled a rebate category for a rebate related to increasing energy efficiency and a dishwasher that is in the rebate category to generate a first purchase amount associated with a credit card not eligible for the rebate and a second purchase amount associated with a checking account eligible for the rebate, the modeler circuit can identify that the first purchase amount without the rebate is higher than the second purchase amount that includes the rebate. The modeler circuit 124 can then model the variation between purchasing the dishwasher with the first purchase amount using the credit card and purchasing the dishwasher with the second purchase amount using the checking account to generate a difference between the first purchase amount and the second purchase amount. In this example, the difference generated by the modeler circuit 124 would be the rebate available to purchases made with the checking account and not available to purchases made with the credit card.

In some embodiments, the modeler circuit 124 can determine that an offer element corresponds to an offer in response to an action received by the content control circuit 128. For example, after receiving a selection of an actionable element of an interface that corresponds to an offer from a user device (e.g., from the I/O device 132, from the content control circuit 128, etc.), the modeler circuit can determine an element related to the offer. The element may be stored in the modeling dataset 122, the data sources 170, or the provider systems 135 and may include content related to the offer such as descriptions of the offer, photographs or videos of the offer, or reviews of the offer. For example, a user of a user device may select an icon on an interface that is related to a food product. After receiving the selection of the icon from the user device, the modeler circuit can determine that a review from the provider systems 135 corresponds to the food product.

In some embodiments, the modeler circuit 124 can determine transaction instrument elements corresponding to a transaction instrument in response to an action received by the content control circuit 128. For example, after receiving a selection of an actionable element of an interface that corresponds to a transaction instrument from a user device (e.g., from the I/O device 132, from the content control circuit 128, etc.), the modeler circuit can determine an element related to the transaction instrument. The element may be stored in the modeling dataset 122, the data sources 170, or the provider systems 135 and may include content related to the transaction instrument such as an available amount of the transaction instrument or a description of the transaction instrument. The available amount is a maximum amount of the transaction instrument available for a transaction request. For example, a user of a user device may select an icon on an interface that is related to a checking account. After receiving the selection of the icon from the user device, the modeler circuit can determine that an account balance from the provider systems 135 corresponds to the checking account.

In some embodiments, the modeler circuit 124 can determine an increased purchase power for exchanging a second amount for an offer using a second transaction instrument instead of exchanging a first amount for the offer using the first transaction instrument. For example, the modeler circuit 124 can determine a ratio between the first amount and the second amount and then multiply the ratio times the first amount to determine how much additional value a user can obtain by exchanging the second amount for the offer using the second transaction instrument instead of exchanging the first amount for the offer using the first transaction instrument. The increased purchase power can then be displayed on the user device of the user so that the user can visually determine the increased purchase power. For example, if a dryer can be purchased for $700 using a home savings account and the dryer can be purchased for $1000 using a checking account, the modeler circuit 124 can determine that exchanging the dryer for $700 using the home savings account instead of $1000 using the checking account results in an increased purchase power of $1428.57. That is, the user can obtain $1428.57 worth of value out of the $700 if the user purchases the dryer for $700 using the home savings account instead of exchanging the $1000 for the dryer using the checking account. In various embodiments, the modeler circuit 124 can determine an increased purchase power for exchanging a third amount for the offer using a third transaction instrument instead of exchanging the first amount for the offer using the first transaction instrument or exchanging the second amount for the offer using the second transaction instrument.

In some embodiments, the data control circuit 126 can be configured to perform data fusion operations, including operations to generate and/or various data structures stored in memory 120 and used by the various circuits described herein. For example, the data manager can communicate with the user device or data sources by collecting, receiving, or identifying data relevant for use by the other circuits. The data control circuit 126 can also be configured to receive a plurality of entity data. In some arrangements, the data control circuit 126 can be configured to receive data regarding the network 130 as a whole instead of data specific to a particular entity. The received data that the data control circuit 126 receives can be data that transaction system 110 aggregates and/or data that the transaction system 110 receives from the data sources 170 and/or any other system described herein (e.g., provider system 135, user device 140).

The content control circuit 128 can include circuitry for storing information such as rules for offer actionable activities for customized user data structures. The content control circuit 128 can receive data for determining or displaying actionable activities to the user from any component of the transaction modeler architecture 100 (e.g., receives amount information for a category from modeler circuit 124 affecting an offer). The content control circuit 128 may additionally store this information in memory 120. In some embodiments, the content control circuit 128 can generate content for displaying to users. The content can be selected from various resources (e.g., a request for an offer from the data control circuit 126). The content control circuit 128 can also be structured to provide content (e.g., via a graphical user interface (GUI)) to the user device 140 over the network 130, for display within the resources. For example, the content control circuit 128 can present a GUI including actionable elements and content associated with an offer. The GUI can be sent via the I/O device 132 to the user device 140 through the network 130.

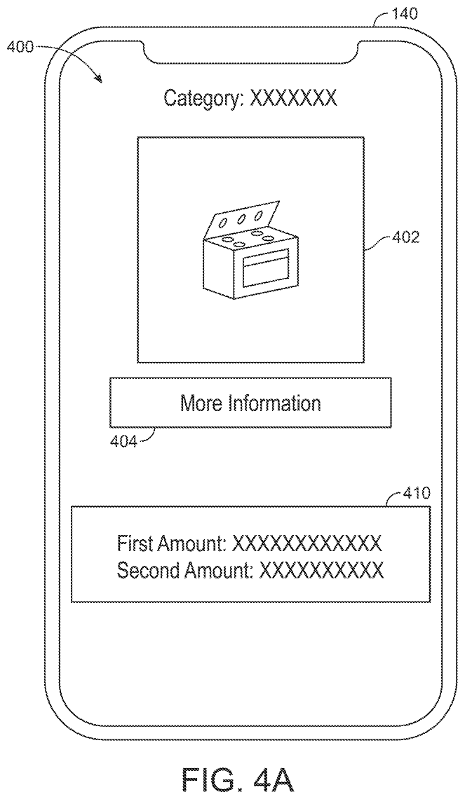

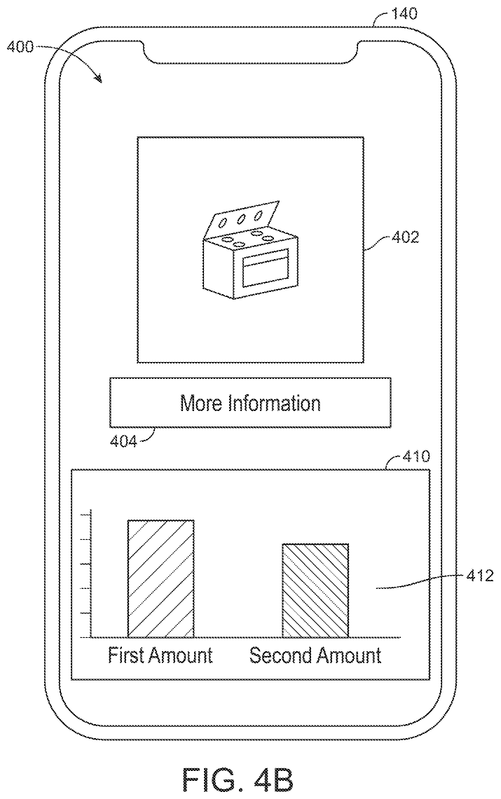

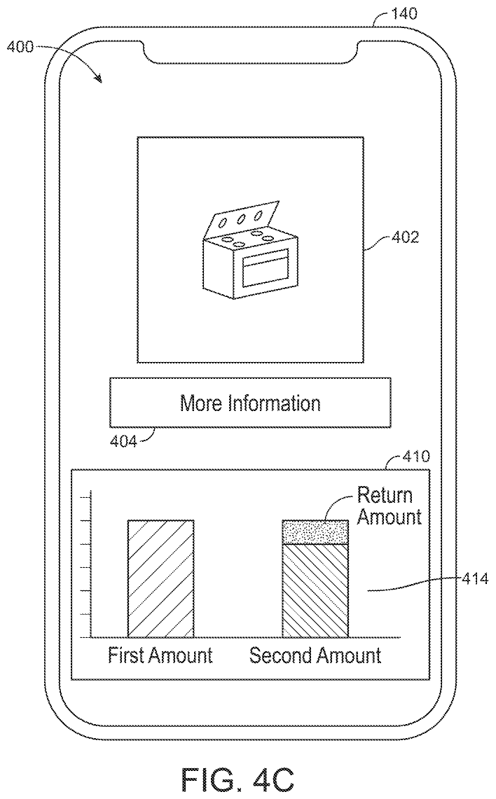

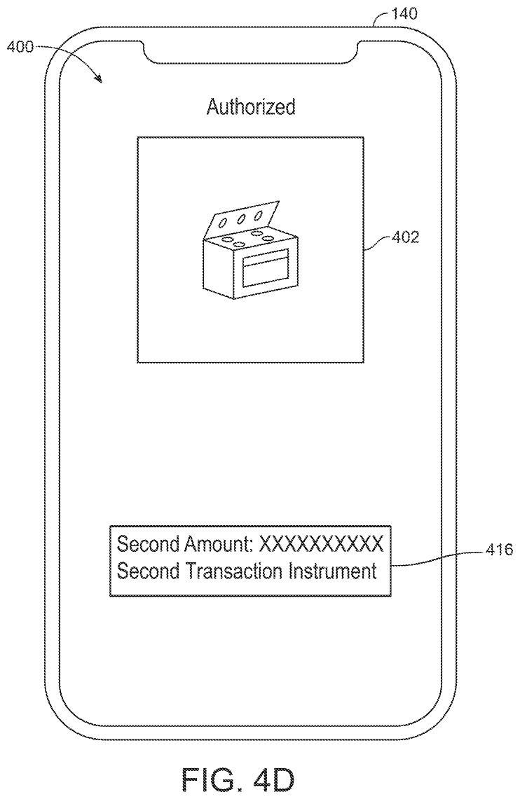

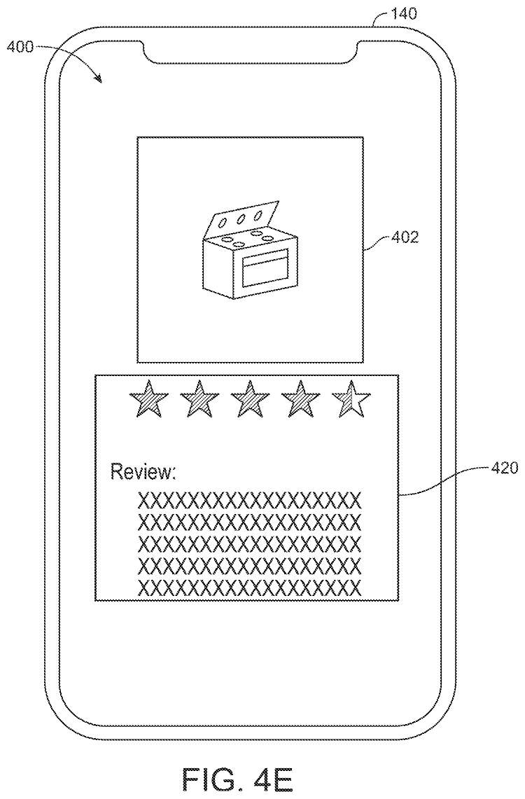

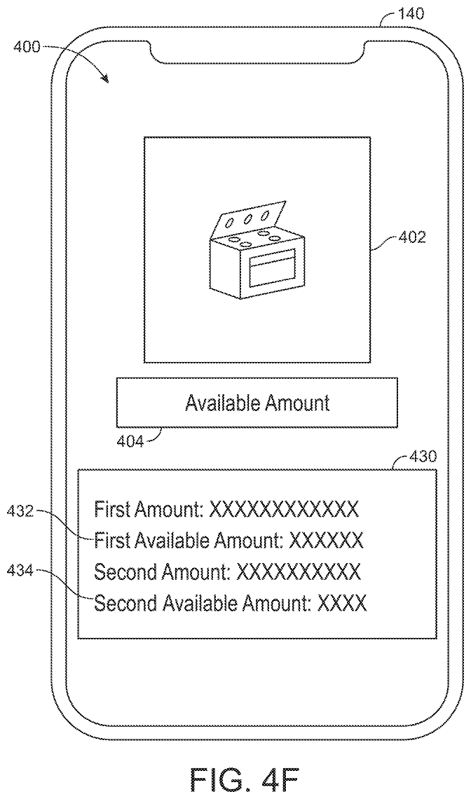

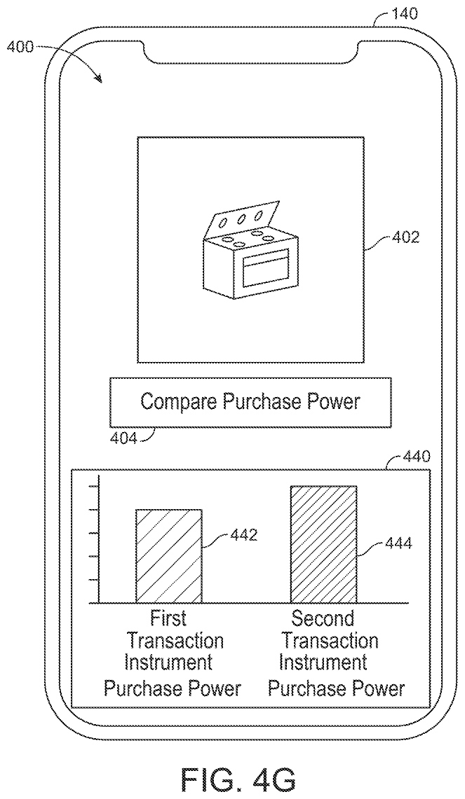

The content control circuit 128 can generate interfaces such as a plurality of customized dashboards, such as those described in detail below, with reference to FIGS. 4A-4G. The content control circuit 128 can generate customized user-interactive dashboards for one or more entities, such as the user device 140, based on data received from the user device 140, data source 170, and/or any other computing device described therein. The generated dashboards can include various data (e.g., data stored in the content control circuit 128 and/or modeling dataset 122) associated with one or more offers such as a category, transaction modeler architecture 100 amounts, photographs or videos, descriptions, and/or others. In certain embodiments, the transaction system 110 includes an application programming interface (API) and/or a software development kit (SDK) that facilitate the integration of other applications with the transaction system 110. For example, the transaction system 110 is configured to utilize the functionality of the user device 140 interacting with the user client application 154 through an API.

Still referring to FIG. 1, the input/output device 132 is structured to receive communications from and provide communications to users associated with the transaction system 110. The input/output device 132 is structured to exchange data, communications, instructions, etc. with an input/output component of the transaction system 110. In one embodiment, the input/output device 132 includes communication circuitry for facilitating the exchange of data, values, messages, and the like between the input/output device 132 and the components of the transaction system 110. In yet another embodiment, the input/output device 132 includes machine-readable media for facilitating the exchange of information between the input/output device and the components of the transaction system 110. In yet another embodiment, the input/output device 132 includes any combination of hardware components, communication circuitry, and machine-readable media.

In some embodiments, the input/output device 132 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output device 132 may provide an interface for the user to interact with various applications stored on the transaction system 110. For example, the input/output device 132 may include a keyboard, a keypad, a mouse, joystick, a touch screen, a microphone, a biometric device, a virtual reality headset, smart glasses, smart headsets, and the like. As another example, input/output device 132, may include, but is not limited to, a television monitor, a computer monitor, a printer, a facsimile, a speaker, and so on. As used herein, virtual reality, augmented reality, and mixed reality may each be used interchangeably, yet refer to any kind of extended reality, including virtual reality, augmented reality, and mixed reality.

The user devices 140 may each similarly include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the transaction system 110. Therefore, it should be understood that the description of the network interface 112, the processing circuit 114, and the input/output device 132 of the transaction system 110 provided above may be similarly applied to the network interface 142, the processing circuit 144, and the input/output device 160 of each of the user devices 140.

In some embodiments, the network interface 142 is similarly structured and used to establish connections with other computing systems (e.g., the transaction system 110, other of the user devices 140, and data sources 170) via the network 130. The network interface 142 may further include any or all of the components discussed above, with reference to the network interface 112. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150 (e.g., user device dataset 152). For example, the user devices 140 may be configured to run an application such as the user client application 154 that is stored in the user device dataset 152. In another example, the user devices 140 may be configured to store various user data, such as, but not limited to, personal user device information (e.g., names, addresses, phone numbers, contacts, call logs, installed applications, and so on), user device authentication information (e.g., username/password combinations, device authentication tokens, security question answers, unique client identifiers, biometric data (such as digital representations of biometrics), geographic data, social media data, application specific data, and so on), and user device provider information (e.g., token information, account numbers, account balances, available credit, credit history, transaction modeler architecture 100 histories, and so on) relating to the various accounts.

Particularly, the user client application 154 can be configured to communicate with the transaction system 110. As such, the user devices 140 can be communicably coupled to the transaction system 110 (e.g., through interactions with the modeler circuit 124, data control circuit 126, and content control circuit 128), and data sources 170. The user client application 154 may therefore communicate with the transaction system 110 and data sources 170 to perform a variety of functions. For example, the user client application 154 is similarly configured to receive user inputs (e.g., via a user interface of the user device 140) to complete interactions during a communication session with transaction system 110. For example, the user client application 154 may be used during a communication session via an API with the analysis system to request additional content, such as a review of an offer. Additionally, the user client application 154 is configured to output information to a display of user device 140 regarding information received from the transaction system 110. For example, the user client application 154 is configured to communicate with a user interface to show graphics regarding content associated with an offer, such as a photograph or video, a review, or a description. Further, a user response to a display of user device 140 regarding information from the transaction system 110 can send a message, task, or instruction to the transaction system 110 via the network 130 that allows for the modeling dataset 122, modeler circuit 124, data control circuit 126, and/or content management circuit 138 to be perform an update.

The user client application 154 is further configured to communicate with the transaction system 110 to allow a user associated with the various user devices to update offer information and/or provide feedback during a communication session based on content from the modeler circuit 124, the data control circuit 126, or the content control circuit 128 via the input/output device 123. The user client application may also be structured to allow the user devices 140 to retrieve and submit requests associated with offers, the selection of actionable elements (e.g., actionable items, etc.), transaction modeler architecture 100 requests, and/or any other type of necessary information to and/or from transaction system 110 during an established sessions, as required to complete the communication session. In some embodiments, the user client application may be configured to temporarily store the requests associated with offers, the selection of actionable elements, transaction modeler architecture 100 requests, and/or any other type of necessary information, which may then be selectively transmitted to the transaction system 110 in response to a user input (e.g., received via the input/output device 160).

The input/output device 160 of each user device 140 may function substantially similar to and include the same or similar components as the input/output device 132 previously described, with reference to the transaction system 110. As such, it should be understood that the description of the input/output device 132 provided above may also be applied to the input/output device 160 of each of the user devices 140. In some embodiments, the input/output device 160 of each user device 140 is similarly structured to receive communications from and provide communications to a user associated with the user device 140.

The data sources 170 can provide data to the transaction system 110 and/or user device 140. In some arrangements, the data sources 170 can be structured to collect data from other devices on network 130 (e.g., user devices 140 and/or other third-party devices) and relay the collected data to the transaction system 110 and/or user device 140. In some embodiments, the transaction system 110 may request data associated with specific data stored in the data source (e.g., data sources 170). For example, in some arrangements, the data sources 170 can support a search or discovery engine for Internet-connected devices. The search or discovery engine may provide data from other providers that, when used to update a category to include or exclude an offer (e.g., category used by the modeler circuit 124 based on data from the modeling dataset 122), will cause an update to an amount for an offer associated with a transaction instrument. The search or discovery engine may also provide data from other providers that, when used to update offers (e.g., offers used by the modeler circuit 124 based on data from the modeling dataset 122), will cause an update to an amount for an offer associate with a transaction instrument.

In some embodiments, the transaction modeler architecture 100 can include provider systems 135. A provider system 135 can be communicated with to obtain or access additional transaction data, where the provider system 135 can be banks, vendors, governmental institutions, or other institutions (e.g., credit card companies, financial institutions (FI), etc.). In some arrangements, provider systems 135 can provide data to the transaction system 110 and/or user device 140. In some arrangements, a provider system 135 can be structured to collect data from other devices on the network 130 (e.g., user devices 140 and/or other third-party devices) and relay the collected data to the transaction system 110 and/or user device 140. In some embodiments the transaction system 110 may request data associated with specific data stored in the provider system 135. For example, in some arrangements, the provider systems 135 can support a search or discovery engine for Internet-connected devices. The search or discovery engine may provide data from other providers that, when used to update a category to include or exclude an offer (e.g., category used by the modeler circuit 124 based on data from the modeling dataset 122), will cause an update to an amount for an offer associated with a transaction instrument. The search or discovery engine may also provide data from other providers that, when used to update offers (e.g., offer used by the modeler circuit 124 based on data from the modeling dataset 122), will cause an update to an amount for an offer associate with a transaction instrument.

In some embodiments, the provider systems 135 can serve as a basis for the transaction system 110 to receive transaction requests. For example, the provider system 135 can receive a request from a user to generate a transaction request for an offer corresponding to a transaction instrument. The provider system 135 can package the offer information and the transaction instrument data into the transaction request and send the transaction request to the transaction system 110 for further processing (e.g., authorization, analysis, assignment of amounts to the transaction request, etc.).

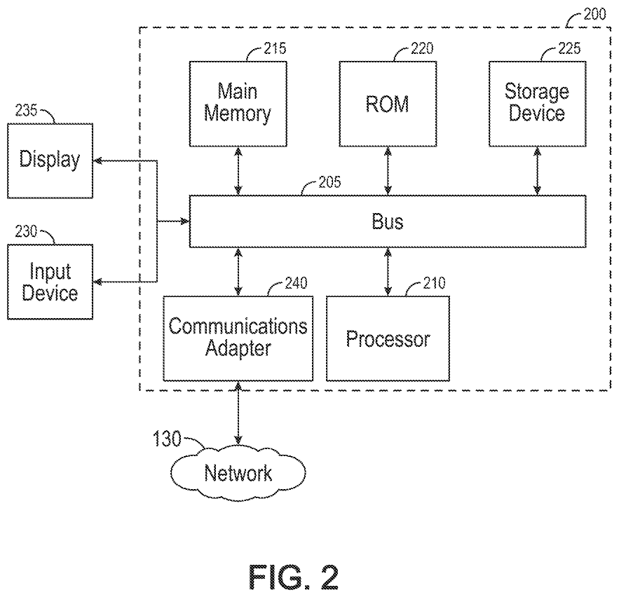

Referring now to FIG. 2, a depiction of a computing system 200 is shown. The computing system 200 that can be used, for example, to implement a transaction modeler architecture 100, transaction system 110, provider systems 135, user devices 140, data sources 170, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk, or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with a computing or communications network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the example processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

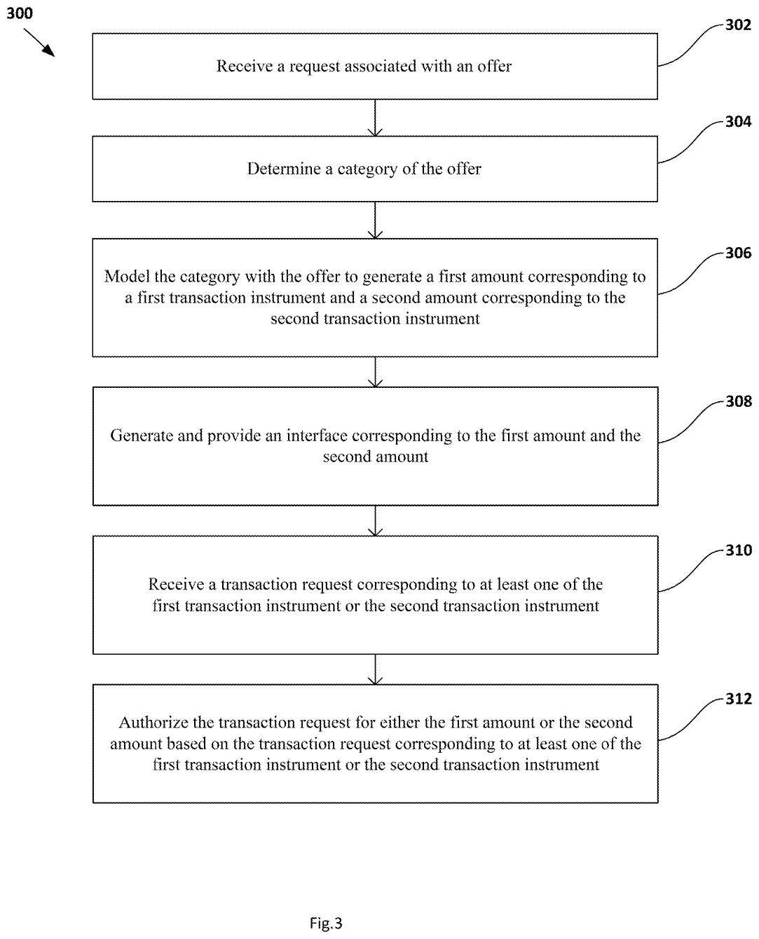

Referring now to FIG. 3, a flowchart for a method 300 of transaction modeling is shown, according to some embodiments. The transaction system 110 can be configured to perform method 300. Further, any computing device described herein can be configured to perform method 300.

In broad overview of method 300, at block 302, the one or more processing circuits (e.g., transaction system 110 in FIG. 1) can receive a request associated with an offer. At block 304, the one or more processing circuits can determine a category of the offer. At block 306, the one or more processing circuits can model the category with the offer to generate a first amount corresponding to a first transaction instrument and a second amount corresponding to a second transaction instrument. At block 308, the one or more processing circuits can generate and provide an interface corresponding to the first amount and the second amount. At block 310, the one or more processing circuits can receive a transaction request corresponding to at least one of the first transaction instrument or the second transaction instrument. At block 312, the one or more processing circuits can authorize the transaction request for either the first amount or the second amount based on the transaction request corresponding to at least one of the first transaction instrument or the second transaction instrument. Additional, fewer, or different operations may be performed depending on the particular arrangement. In some embodiments, some, or all operations of method 300 may be performed by one or more processors executing on one or more computing devices, systems, or servers, and some steps can be performed by different processors than other steps. In various embodiments, each operation may be re-ordered, added, removed, or repeated.

The GUI of method 300 may be provided by and/or accessible by the user client application 154 and content control circuit 128, for example. The method 300 may be performed by the transaction system 110 or the user device 140, described above pertaining to FIGS. 1 & 2. In some embodiments, method 300 begins in response to receiving, by a user device (e.g., user device 140), through a user client application (e.g., user client application 154), data from a dataset (e.g., user device dataset 152). The data can include category data, such as changes to offers included in a category, or user data, such as search history, transaction history, activity data, and account data. In some embodiments, method 300 begins when the transaction system 110 receives data via the network 130.

Referring now to FIG. 3 in more detail at block 302, the one or more processing circuits can receive a request associated with an offer. In some embodiments, the request may be received from a graphical user interface (GUI) presented on a user device. In some embodiments, the request received from the GUI presented on the user device may be an active request associated with the offer from a user (e.g., a selection by the user on the user device associated with the offer, a search by the user for the offer, etc.). In some embodiments, the request received from the GUI presented on the user device may be a background request associated with the offer (e.g., an application on the user device creates the request based on advertising data, an application on the user device creates the request based on recommended content data, etc.). In some embodiments, the request may be associated with more than one offer (e.g., a first offer, a second offer, a third offer, etc.).

In some embodiments, the request associated with an offer may be received from an entity. In these cases, the request may be associated with user data corresponding to a user of a user device. The entity may determine through the user data that the user has an amount associated with a transaction instrument that is sufficient to make a purchase associated with the offer. The entity then may provide the request associated with the offer to the one or more processing circuits so that the one or more processing circuits alert the user that the user may make the purchase associated with the offer. For example, a financial institution may determine that a user has a balance in a home savings account that is sufficient to purchase an energy efficient refrigerator. The entity can then provide a request associated with the energy efficient refrigerator to the one or more processing circuits such that the method 300 proceeds with regards to a user of the user device and the energy efficient refrigerator.

Referring now to FIG. 3 in more detail at block 304, the one or more processing circuits (e.g., transaction system 110 in FIG. 1) can determine a category associated with the offer received in the request at block 302. In some embodiments, the process of determining the category of the offer can include lookup tables, machine learning, statistical analysis, and pattern recognition to establish relationships between the category and the offer. In some embodiments, the method 300 can include determining more than one category for the offer (e.g., a first category, a second category, a third category, etc.). In some embodiments, the method 300 can include determining the category for more than one offer. In various embodiments, the method 300 can include determining more than one category for more than one offer. In some embodiments, the method 300 may include referencing third party systems to determine the category associated with the offer. For example, data provided by provider systems (e.g., provider systems 135) can allow the method 300 to identify offers associated with categories defined by the provider systems 135. For example, data of a third party vendor such as a home improvement store may provide the transaction system 110 with data regarding categories that may be associated with offers that are sold by the home improvement stores.

In some embodiments, the offer may be assigned a category code (e.g., a merchant code, a grouping code, etc.) that allows for the method 300 to determine the category associated with the offer. For example, an offer may be assigned a specific code that associates the offer with a specific vendor, a specific type of category, and/or a specific transaction condition, such that the method 300 may determine the category for the offer that is associated with the specific vendor, the specific type of category, and/or the specific transaction condition. For example, a bicycle may be assigned an eco-friendly transportation code that allows for the method 300 to determine that the bicycle is associated with an eco-friendly transportation category.

In some embodiments, the method 300 can include referencing multiple of third party systems, data sources (e.g., data sources 170), and/or modeling data (e.g., modeling dataset 122) to determine more than one of the categories associated with the offer. For example, the method 300 can include determining that the offer is associated with a first category using the third party system, that the offer is associated with a second category using the data sources, and a third category using the modeling data. For example, the method 300 can determine that a solar panel is associated with an on-sale category using the third party system (e.g., a vendor system), that the solar panel is associated with a government rebate using the data sources (e.g., a search or discovery engine that provides data on government programs), and that the solar panel is associated with a points reward associated with a transaction instrument using the modeling data (e.g., data from the financial institution associated with the transaction instrument).

At block 306, the one or more processing circuits can model the category with the offer to generate a first amount corresponding to a first transaction instrument and a second amount corresponding to a second transaction instrument. In some embodiments, the process of modeling can include using techniques such as machine learning, statistical analysis, and pattern recognition to establish relationships between different categories and transaction instruments and generate transaction amounts based on those relationships. In some embodiments, modeling can begin with the selection of an appropriate model based on the category and the offer. It should be understood that the term modeling herein encompasses a wide range of techniques and approaches aimed at understanding relationships within data. This can include anything from statistical methods and rule-based systems to machine learning algorithms, depending on the nature of the data. Thus, modeling involves selecting techniques based on the specific characteristics of the data, ensuring that the chosen method or methods accurately captures relationships.

In some embodiments, the processing circuits can utilize pattern recognition methodologies to identify transaction instruments associated with a user of the user device that provided the request associated with the offer at block 302 and utilize that data to determine resulting transaction instruments of the model. For example, pattern recognition applied to activity data of the user of the user device can discern transaction instruments utilized by the user. By integrating these transaction instruments with the category determined for the offer at block 304, the processing circuits can generate amounts for the offer corresponding to the transaction instrument utilized by the user of the user device. For example, the processing circuits can identify that the user of the user device has a checking account and a home savings account based on previous transaction data. The processing circuits can then model the category with the offer to generate a first amount corresponding to the checking account and a second amount corresponding to the home savings account such that the first amount and the second amount generated for the user of the user device apply to the checking account and the home savings account held by the user of the user device.

In some embodiments, the processing circuits may model an offer and a category of the offer with a transaction instrument to generate an amount associated with the transaction instrument. For example, the model of the method 300 may compare a first category of an offer with a list of categories associated with a first transaction instrument. If the first category is included in the list of categories associated with the first transaction instrument, then the model may generate a first amount for the offer corresponding with the first transaction instrument. If the first category is not included in the list of categories associated with the first transaction instrument, then the model may generate a second amount for the offer corresponding with the first transaction instrument. In some embodiments, the second amount generated by the model of the method 300 for the case where the category of the offer is included in the list of categories associated with the first transaction instrument is lower than the first amount generated by the model of the method 300 for the case where the category of the offer is not included in the list of categories associated with the first transaction instruments. For example, the method 300 at block 306 may determine that a can of paint belongs in a home decoration category. If a list of categories associated with a home savings account does not include the home decoration category, then the model of the method 300 may generate a first amount for the can of paint associated with the home savings account. If the list of categories associated with the home savings account includes the home decoration category, then the model of the method 300 may generate a second amount for the can of paint associated with the home savings account. In some embodiments, the second amount for the can of paint is less than the first amount for the can of paint.

In some embodiments, the processing circuits can identify at least one variation between exchanging a first amount with a first transaction instrument for an offer and exchanging a second amount with a second transaction instrument for the offer. The variation represents a difference between using the first transaction instrument to make a purchase associated with the first offer and using the second transaction instrument to make the purchase associated with the offer. For example, the variation may be that the first amount is higher than the second amount, that the second amount results in a bonus amount being returned than the first amount, that the second amount results in a tax rebate that is higher than the first amount, and/or additional differences between exchanging the first amount with the first transaction instrument for the offer and exchanging the second amount with the second transaction instrument for the offer. These variations may allow for a user to reduce an amount used to make the purchase associated with the offer. Subsequently, the processing circuits may model the at least one variation between exchanging the second amount with the second transaction instrument for the offer and exchanging the first amount with the first transaction instrument for the offer to generate a value offset corresponding to the variation. The value offset is a representation of a variation amount of the variation between exchanging the first amount with the first transaction instrument for the offer and exchanging the second amount with the second transaction instrument for the offer. For example, the value offset may be a difference between the second amount and the first amount, a difference between the bonus amount of the first amount and the second amount, a difference between the tax rebate of the first amount and the second amount, and/or additional variation amounts of the difference between exchanging the first amount with the first transaction instrument for the offer and exchanging the second amount with the second transaction instrument for the offer.

In some embodiments, the model parameters can be trained and optimized using the cleaned, classified, and linked categories, offers, transaction amounts, and transaction instruments. This training process can include using algorithms to adjust the model parameters such that the error between the model's predictions and the actual outcomes is minimized. The modeling process can also include feature engineering, which is the process of creating new features or modifying existing ones to improve the model's power. For example, instead of generating a first amount corresponding to a first transaction instrument by modeling the category and the offer, a feature that sets the first amount equal to a base amount that is an industry accepted base value of an offer might result in a more efficient model.

Once one or more models or techniques are trained and/or optimized, the processing circuits can use the model to generate a first amount corresponding to a first transaction instrument and a second amount corresponding to a second transaction instrument. The first amount and the second amount can be a mathematical representation, a decision tree, a set of rules, or any other structure that captures the relationships between different data points. Moreover, the modeling process can include various safeguards to ensure privacy and security of user data (e.g., anonymizing the data).

In some embodiments, the processing circuits can use rule-based systems to model the category and the offer. Rule-based systems can be predefined rules that are created by the processing circuits (or domain experts) to infer outcomes based on given conditions. For example, if a user of the user device that provided the request associated with the offer at block 302 consistently conducts transactions using a first transaction instrument or a second transaction instrument, a rule might state that the user is likely to do the same in the future. This rule can then be applied to the process to limit the process to modeling a first amount corresponding to the first transaction instrument and a second amount corresponding to a second transaction instrument. In some embodiments, the processing circuits can use statistical methods for modeling. This can involve approaches like time series analysis or trend analysis. For instance, time series analysis can be used to identify patterns in past category data, such as seasonal trends, cyclical patterns, or overall transaction trends. If an offer is consistently added to a category during the holiday season, time series analysis can identify this pattern and predict a similar addition for the next holiday season.

Referring now to FIG. 3 in more detail at block 308, the one or more processors can generate and provide an interface corresponding to the first amount and the second amount. In some embodiments, the interface is provided to a graphical user interface (GUI) of a user device (e.g., the user device 140) and includes at least one actionable element and content associated with the offer. In some embodiments, the method 300 at block 308 can present the GUI through the operating system of the user device, display hardware of the user device, graphics rendering of the user device, windowing system of the user device, among other means. For example, the GUI system can incorporate event-driven programming, where actions or events trigger corresponding responses. In some embodiments, the operation system and applications of the devices used by the method 300 can use implementations such as event handlers to update the GUI.

Still referring to FIG. 3 in more detail at block 308, the one or more processors can establish a communication session between the transaction system 110 and other external systems or devices such as a user device. To establish a communication session via an application programming interface, the method 300 at block 308 may establish connections through connection initiation, addressing and identification, handshake and negotiation, authentication and authorization, channel establishment, data exchange, or session maintenance. The exact process and protocols used to establish a communication session can vary depending on the specific devices, network infrastructure, and communication technologies involved. Different protocols, such as TCP/IP, Bluetooth, Wi-Fi, or specific application-layer protocols, have their own mechanisms for session establishment. When initiating a connection, the initiating device, which can be referred to as the client, sends a request to establish a connection with the target device, which can be the server. This request can be initiated through various means, such as a physical cable connection, wireless signals, or network protocol. Addressing and identification involves the initiating device specifying the address or identifier of the target device it wishes to communicate with. This can be an IP address, domain name, MAC address, or any other unique identifier depending on the communication protocol being used. Handshake and negotiation involve the devices engaging in a handshake process to negotiate communication parameters and establish a common set of rules for the session. This includes agreeing on protocols, encryption methods, data formats, and other communication settings. Authentication and authorization involve the devices performing authentication and authorization procedures to ensure the identity and permissions of each other. This can involve exchanging credentials, digital certificates, or other security measures to validate the devices' authenticity and grant access to the requested resources. Channel establishment follows the process of once the handshake is successful and authentication is completed, the devices establish a communication channel. This can involve creating a logical connection, allocating network resources, or establishing a secure tunnel to facilitate data exchange. Data exchange involve establishing a communication channel, and then allowing the devices to start exchanging data. This can involve sending messages, transmitting files, streaming media, or any other form of information exchange based on the intended purpose of the session. Session maintenance involves the devices periodically exchanging control messages to ensure the session remains active and monitor the connection's integrity during the communication session. This includes handling potential errors, retransmission of lost data, and managing any necessary protocol-specific maintenance tasks.

Still referring to FIG. 3 in more detail at block 308, the content associated with the offer can be comprehensive of many types of content associated with the offer. In some embodiments, the content associated with the offer can be a comparison of a ratio between a first amount for an offer corresponding to a first transaction interface and a second amount for the offer corresponding to a second transaction interface. For example, the content may be a pie chart showing the ratio between the first amount and the second amount, a bar chart showing the ration between the first amount and the second amount, and/or another visualization of the ration between the first amount and the second amount. In some embodiments, the content associated with the offer can be a comparison of the first amount for an offer corresponding to a first transaction interface and a combination of a second amount for the offer corresponding to the second transaction interface and a return amount that is transferred to the second transaction instrument subsequent to an authorization of a transaction request. The content associated with the offer can also include a variation between the first amount and the combination of the second amount and the return amount. For example, after the completion of a purchase of a television from a vendor using a vendor credit card, a rebate may be returned to the vendor credit card that would not be returned to a non-vendor credit card that is not the vendor credit card. The content associated with the television that is generated and provided to the GUI can be a comparison of a first amount that would be purchased from the non-vendor credit card for the television to a combination of a second amount that would be purchased from the non-vendor credit card for the television and the rebate that may be returned to the vendor credit card after the completion of the purchase of the television.

Still referring to FIG. 3 in more detail at block 308, a selection of the actionable element can be comprehensive of many activities. In some embodiments, the selection of the actionable activity can be associated with the value offset modeled at block 306. For example, in response to a selection of the actionable activity, the processing circuits can generate and provide additional information on the value offset to the GUI of the user device. The additional information on the value offset can include a display that includes a visualization of the value offset in relation to a variation between exchanging a first amount with a first transaction instrument for an offer and exchanging a second amount with a second transaction instrument for the offer. In some embodiments, the selection of the actionable element can be associated with updating the interface corresponding to an offer including content of the offer or a review of the offer. For example, in response to the selection of the actionable element, the processing circuits can update the interface to include a description of the offer. In some embodiments, the selection of the actionable element can be associated with updating the interface to include information corresponding to a transaction instrument. For example, in response to the selection of the actionable element, the processing circuits can update the interface to include a transaction instrument element corresponding to the transaction instrument. In some embodiments, the transaction instrument element corresponds to an available amount corresponding to the transaction instrument, where the available amount is a maximum amount of the transaction instrument available for a transaction request. For example, the transaction instrument element corresponds to a first available amount corresponding to the first transaction instrument and a second available amount corresponding to the second transaction instrument, where the first available amount is a first maximum amount of the first transaction instrument available for a transaction request and the second available amount is a second maximum amount of the second transaction instrument available for a transaction request. For example, the available amount may be an account balance in a checking account or an available credit on a credit card.

Still referring to FIG. 3 in more detail at block 308, generating and providing the interface including an actionable element and content associated with an offer can further include requesting and receiving the content associated with the offer. In some embodiments, the request for the content may be provided via an application programming interface (API) of a merchant computing system and then the content associated with the offer can be received via the API. In some embodiments, the content may include a photograph or video of the offer, a description of the offer, or other content associated with the offer.

Referring now to FIG. 3 in more detail at block 310, the one or more processing circuits can receive a transaction request corresponding to the first transaction instrument or the second transaction instrument. In some embodiments, the request may be received from a merchant computing system associated with a vendor of the offer. For example, after receiving the interface generated and provided at block 308 a user of the user device can initiate a transaction for the offer using the first transaction instrument or the second transaction instrument through the merchant computing system. The merchant computing system can then send the transaction request to the one or more processing circuits. For example, the user of the user device may initiate a purchase of a vehicle though a website of a vehicle dealership using a check. The computing system of the vehicle dealership can generate a purchase request and can then communicate the purchase request to the one or more processing circuits. In some embodiments, the transaction request includes transaction information of an offer. For example, the transaction request can include identifying information regarding the offer such that the one or more processing circuits may determine properties of the offer from the transaction request.

Referring now to FIG. 3 in more detail at block 312, the one or more processors can authorize the transaction request received by the one or more processors at block 310 for either the first amount or the second amount based on the transaction request corresponding to the first transaction instrument or the second transaction instrument. For example, the one or more processors can determine that the transaction request received from the merchant computing system corresponds to either the first amount or the second amount and corresponds to the first transaction instrument or the second transaction instrument and then approve the transaction request such that a vendor of the merchant computing system receives the first amount or the second amount from the first transaction instrument or the second transaction instrument. For example, the one or more processors can receive a purchase request corresponding to a boat from a vendor system that corresponds to a price and a checking account. The one or more processors can then authorize the purchase request such that an amount equal to the price is removed from the checking account and transferred to a vendor.

In some embodiments, prior to authorizing the transaction request, the one or more processors can subsequently configure the transaction request to correspond to the first amount for the offer. The one or more processors can configure the transaction request by embedding the first amount in the transaction request. After configuring the transaction request to correspond to the first amount, the one or more processors can subsequently validate that the transaction request corresponds to the first amount and corresponds to the second transaction instrument. In response to the transaction request corresponding to the first amount and corresponding to the second transaction instrument, the one or more processors adjust the transaction request to correspond to the second amount by removing the first amount from the transaction request and embedding the second amount in the transaction request. For example, prior to authorizing a purchase request, the processors configure the purchase request to correspond to a first price that corresponds to a checking account. The processors then validate that the purchase request corresponds to the first price and corresponds to a home savings account. If the purchase request corresponds to the first price and does not correspond to the home savings account (e.g., the checking account), then the processors proceed with authorizing the purchase request that corresponds to the first price. If the purchase request corresponds to the first price and corresponds to the home savings account, then the processors adjust the transaction request to correspond to a second price before proceeding with authorizing the purchase request. In this way, the processors can ensure that the purchase request corresponds to the second price when the purchase request corresponds to the home savings account and that the purchase request corresponds to the first price when the purchase request does not correspond to the home savings account before authorizing the purchase request.

In some embodiments, prior to authorizing the transaction request, the one or more processors can subsequently configure the transaction request to correspond to the second amount for the offer. The one or more processors can configure the transaction request by embedding the second amount in the transaction request. After configuring the transaction request to correspond to the second amount, the one or more processors can subsequently validate that the transaction request corresponds to the second amount and corresponds to the first transaction instrument. In response to the transaction request corresponding to the second amount and corresponding to the first transaction instrument, the one or more processors adjust the transaction request to correspond to the first amount by removing the second amount from the transaction request and embedding the first amount in the transaction request. For example, prior to authorizing a purchase request, the processors configure the purchase request to correspond to a second price that corresponds to a home savings account. The processors then validate that the purchase request corresponds to the first price and corresponds to a checking account. If the purchase request corresponds to the second price and does not correspond to the checking (e.g., the home savings account), then the processors proceed with authorizing the purchase request that corresponds to the second price. If the purchase request corresponds to the second price and corresponds to the checking account, then the processors adjust the transaction request to correspond to a first price before proceeding with authorizing the purchase request. In this way, the processors can ensure that the purchase request corresponds to the first price when the purchase request corresponds to the checking account and that the purchase request corresponds to the second price when the purchase request does not correspond to the checking account before authorizing the purchase request.

Referring now to FIG. 4A, an illustration of a configuration of a user interface 400 on user device 140 is shown. The user interface 400 may be presented within the user client application 154. In some embodiments, the user interface 400 is generated and provided by the content control circuit 128. The user interface 400 can contain content related to an offer (e.g., content 402) such as photographs, videos, descriptions, etc. The user interface 400 can also contain an actionable activity or action input element (e.g., actionable button 404). The user interface 400 can also list a category related to the offer. In some embodiments, the user interface 400 may contain one or more actionable (or interactable) buttons or items (e.g., actionable button 404) that influences an actionable activity. In some embodiments, the actionable button 404, if selected by the user, can display content associated with an offer, display a review associated with an offer, display a balance of a transaction instrument, create a transaction request for an offer, and/or other mechanisms to assist a user with making a purchase associated with an offer. In some embodiments, the user interface 400 can direct the user to provide an input to the user device 140. In some embodiments, the input assists the user to with making a purchase associated with an offer. In some embodiments, the prompt states that the input will provide the user with more information on the offer. In some embodiments, the prompt states the information that will be provided to the user after the user performs the input. In some embodiments, the input includes the user pressing the actionable button 404 presented on the screen of the user device 140. In some embodiments, the user device 140 is a mobile device, such as a cellular phone and/or smart phone. The user interface 400 can contain content 410 relating to a first amount for the offer corresponding to a first transaction instrument and a second amount for the offer corresponding to a second transaction instrument. In some embodiments depicted in FIG. 4A, the first amount and the second amount are displayed as text and/or numerical values that correspond to the first amount and the second amount. In other embodiments depicted in FIG. 4B or 4C, the first amount and the second amount are displayed graphically.

Referring now to FIG. 4B, an illustration of a configuration of the user interface 400 on user device 140 is shown. The user interface 400 may be presented within the user client application 154. In some embodiments, the user interface 400 is generated and provided by the content control circuit 128. The user interface 400 can include the content 402 related to the offer and actionable button 404 described in relation to FIG. 4A above. The user interface 400 can include content 410 relating to the first amount for the offer corresponding to the first transaction instrument and the second amount for the offer corresponding to the second transaction instrument. In some embodiments depicted in FIG. 4B, the user interface contains a graphical representation 412 of a first amount for the offer corresponding to a first transaction instrument and a second amount for the offer corresponding to a second transaction instrument. The graphical representation 412 can be a pie chart showing the ratio between the first amount and the second amount, a bar chart showing the ration between the first amount and the second amount, and/or another visualization of the ration between the first amount and the second amount. In some embodiments, the user interface 400 may change the form of the graphical representation 412 at the selection of an actionable activity. For example, the user interface 400 may change the graphical representation 412 from a pie chart to a bar chart at the selection of the actionable button 404.

Referring now to FIG. 4C, an illustration of a configuration of the user interface 400 on user device 140 is shown. The user interface 400 may be presented within the user client application 154. In some embodiments, the user interface 400 is generated and provided by the content control circuit 128. The user interface 400 can include the content 402 related to the offer and an actionable button 404 described in relation to FIG. 4A above. The user interface 400 can include content 410 relating to the first amount for the offer corresponding to the first transaction instrument and the second amount for the offer corresponding to the second transaction instrument. In some embodiments depicted in FIG. 4C, the user interface contains a graphical representation 414 of a first amount for the offer corresponding to a first transaction instrument and combination of a second amount for the offer corresponding to a second transaction instrument and a return amount corresponding to the second transaction instrument. The return amount can be the amount returned to the second transaction instrument after a transaction request corresponding to the second amount and the second transaction instrument is completed. In some embodiments, the return amount can be a tax rebate, a credit card bonus, a vendor rebate, or another form of an amount being returned to an account after a transaction is completed. The graphical representation 414 can be a pie chart showing the ratio between the first amount and the combination of the second amount and the return amount, a bar chart showing the ration between the first amount and the combination of the second amount and the return amount, and/or another visualization of the ration between the first amount and the combination of the second amount and the return amount. In some embodiments, the user interface 400 may change the form of the graphical representation 414 at the selection of an actionable activity. For example, the user interface 400 may change the graphical representation from a pie chart to a bar chart at the selection of an actionable button 404.

Referring now to FIG. 4D, an illustration of a configuration of a user interface 400 on user device 140 is shown. The user interface 400 may be presented within the user client application 154. In some embodiments, the user interface 400 is generated and provided by the content control circuit 128. The user interface 400 can include the content 402 related to the offer described in relation to FIG. 4A above. The configuration can contain a notification 416 that a transaction of an amount for an offer corresponding to a transaction instrument has been authorized. For example, after the processing circuits have authorized the transaction request corresponding to the second amount and corresponding to the second transaction instrument, the system can display a message that the transaction request was authorized for the second amount and corresponded to the second transaction instrument.

Referring now to FIG. 4E, an illustration of a configuration of a user interface 400 on user device 140 is shown. The user interface 400 may be presented within the user client application 154. In some embodiments, the user interface 400 is generated and provided by the content control circuit 128. The user interface 400 can include the content 402 related to the offer described in relation to FIG. 4A above. The configuration can contain additional content 420 associated with the offer. In some embodiments, the user interface 400 may present the additional content associated with the offer after the actionable activity is selected. The actionable activity may be selected on the user device 140. In some embodiments, the additional content associated with the offer may include a review of the offer, a photograph or video of the offer, a description of the offer, or a link to a third-party website related to the offer. For example, after the actionable button 404 is selected, the user interface 400 can display a review of the offer including a rating of the offer and an experience corresponding to the offer.

Referring now to FIG. 4F, an illustration of a configuration of a user interface 400 on user device 140 is shown. The user interface 400 may be presented within the user client application 154. In some embodiments, the user interface 400 is generated and provided by the content control circuit 128. The user interface 400 can include the content 402 related to the offer and the actionable activity 404 described in relation to FIG. 4A above. The configuration can contain additional content 430 associated with a transaction instrument. In some embodiments, the user interface 400 may present the additional content 430 associated with the transaction instrument after the actionable activity is selected. The actionable activity may be selected on the user device 140. In some embodiments, the additional content 430 associated with the transaction instrument may include an available balance of the transaction instrument, a description of the transaction instrument, a photograph or video associated with the transaction instrument, or a link to a website related to the transaction instrument. For example, after the actionable button 404 is selected, the user interface 400 can display a first available amount of a first transaction instrument and a second available amount of a second transaction instrument, so that the first available amount can be compared to the first amount and the second available amount can be compared to the second amount.

Referring now to FIG. 4G, an illustration of a configuration of a user interface 400 on user device 140 is shown. The user interface 400 may be presented within the user client application 154. In some embodiments, the user interface 400 is generated and provided by the content control circuit 128. The user interface 400 can include the content 402 related to the offer and the actionable activity 404 described in relation to FIG. 4A above. The configuration can contain additional content 440 associated with a purchase power of a transaction instrument. In some embodiments, the user interface 400 may present the purchase power with the transaction instrument after the actionable activity is selected. The actionable activity may be selected on the user device 140. In some embodiments, the purchase power associated with the transaction instrument may include a projection of how much additional value a user can obtain by exchanging an amount for an offer using the transaction instrument. For example, if a dryer can be purchased for $700 using a home savings account and the dryer can be purchased for $1000 using a checking account, the user interface 400 can present that exchanging the dryer for $700 using the home savings account instead of $1000 using the checking account results in an increased purchase power of $1428.57. That is, the user can obtain $1428.57 worth of value out of the $700 if the user purchases the $700 for the dryer using the home savings account instead of exchanging the $1000 for the dryer using the checking account.

It should be understood that no claim element herein is to be construed under the provisions of 35 U.S.C. § 112(f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

What is claimed is:

1. A system comprising:
a processing circuit comprising memory and one or more processors, the processing circuit configured to:
receive, from a graphical user interface (GUI) presented on a user device, a request associated with an offer;
generate a first amount and a second amount for the offer based on a category of the offer, wherein the first amount corresponds to a first transaction instrument and the second amount corresponds to a second transaction instrument;
generate and provide, to the GUI of the user device, an interface for display comprising the first amount in association with the first transaction instrument, the second amount in association with the second transaction instrument, an actionable element, and content associated with the offer;
receive, from a merchant computing system, a transaction request corresponding to at least one of the first transaction instrument or the second transaction instrument, wherein the transaction request comprises transaction information associated with the offer; and
authorize the transaction request for either the first amount or the second amount based on the transaction request corresponding to at least one of the first transaction instrument or the second transaction instrument.

2. The system of claim 1, wherein the processing circuit is further configured to:
identify a variation between exchanging the second amount with the second transaction instrument for the offer and exchanging the first amount with the first transaction instrument for the offer;
model the variation between exchanging the second amount with the second transaction instrument for the offer and exchanging the first amount with the first transaction instrument for the offer to generate a value offset, wherein the value offset corresponds to exchanging the second amount with the second transaction instrument for the offer instead of exchanging the first amount with the first transaction instrument for the offer; and
update the interface comprising the value offset, wherein the value offset is associated with the actionable element of the interface.

3. The system of claim 2, wherein the variation between exchanging the second amount with the second transaction instrument for the offer and exchanging the first amount with the first transaction instrument for the offer is that the second amount is less than the first amount; and
wherein the content of the interface comprises a comparison of a ratio between the first amount and the second amount.

4. The system of claim 2, wherein the variation between exchanging the second amount with the second transaction instrument for the offer and exchanging the first amount with the first transaction instrument for the offer is that a return amount is transferred to the second transaction instrument subsequent to authorizing the transaction request; and
wherein the content of the interface comprises a comparison of the first amount and the variation between the second amount and the return amount.

5. The system of claim 1, wherein prior to authorizing the transaction request the memory and the processing circuit is further configured to:
configure the transaction request to correspond to the first amount for the offer, wherein configuring the transaction request comprises embedding the first amount in the transaction request; and
validate that the transaction request corresponds to the first amount and corresponds to the second transaction instrument, and wherein in response to the transaction request corresponding to the first amount and corresponding to the second transaction instrument, the transaction request is adjusted to correspond to the second amount, wherein adjusting the transaction request comprises removing the first amount from the transaction request and embedding the second amount in the transaction request.

6. The system of claim 1, wherein prior to authorizing the transaction request the processing circuit is further configured to:
configure the transaction request to correspond to the second amount for the offer, wherein configuring the transaction request comprises embedding the second amount in the transaction request; and
validate that the transaction request corresponds to the second amount and corresponds to the first transaction instrument, and wherein in response to the transaction request corresponding to the second amount and corresponding to the first transaction instrument, the transaction request is adjusted to include the first amount instead of the second amount, wherein adjusting the transaction request comprises removing the second amount from the transaction request and embedding the first amount in the transaction request.

7. The system of claim 1, wherein in response to a selection of the actionable element, the processing circuit is further configured to:
determine an offer element corresponds to the offer; and
update the interface corresponding to the offer element, wherein the offer element comprises the content of the offer or a review of the at least one offer.

8. The system of claim 1, wherein in response to a selection of the actionable element, the processing circuit is further configured to:
determine a transaction instrument element is at least one of the first transaction instrument or the second transaction instrument; and
update the interface corresponding to the transaction instrument element, wherein the transaction instrument element corresponds to at least one of a first available amount corresponding to the first transaction instrument or a second available amount corresponding to the second transaction instrument, wherein the first available amount is a first maximum amount of the first transaction instrument available for the transaction request and the second available amount is a second maximum amount of the second transaction instrument available for the transaction request.

9. The system of claim 1, wherein the processing circuit is further configured to:
model the category with the offer to generate a third amount for the offer, wherein the third amount corresponds to a third transaction instrument;
update the interface corresponding to the first amount and the second amount to also correspond to the third amount;
receive, from the merchant computing system, the transaction request corresponding to at least one of the first transaction instrument, the second transaction instrument, or the third transaction instrument, wherein the transaction request comprises the transaction information associated with the offer; and
authorize the transaction request for either the first amount, the second amount, or the third amount based on the transaction request corresponding to at least one of the first transaction instrument, the second transaction instrument, or the third transaction instrument.

10. The system of claim 1, wherein generating and providing the interface including the actionable element and the content associated with the offer further comprises:
requesting and receiving, via an application programming interface (API) of the merchant computing system, the content associated with the offer, wherein the content comprises at least one of a photograph or video of the offer or a description of the offer.

11. A method comprising:
receiving, from a graphical user interface (GUI) presented on a user device, a request associated with an offer;
determining a category of the offer;
modeling the category with the offer to generate a first amount and a second amount for the offer, wherein the first amount corresponds to a first transaction instrument and the second amount corresponds to a second transaction instrument;
generating and providing, to the GUI of the user device, an interface corresponding to the first amount and the second amount, wherein the interface comprises an actionable element and content associated with the offer;
receiving, from a merchant computing system, a transaction request corresponding to at least one of the first transaction instrument or the second transaction instrument, wherein the transaction request comprises transaction information associated with the offer; and
authorizing the transaction request for either the first amount or the second amount based on the transaction request corresponding to at least one of the first transaction instrument or the second transaction instrument.

12. The method of claim 11, further comprising:
identifying a variation between exchanging the second amount with the second transaction instrument for the offer and exchanging the first amount with the first transaction instrument for the offer;
modeling the variation between exchanging the second amount with the second transaction instrument for the offer and exchanging the first amount with the first transaction instrument for the offer to generate a value offset, wherein the value offset corresponds to exchanging the second amount with the second transaction instrument for the offer instead of exchanging the first amount with the first transaction instrument for the offer; and
updating the interface comprising the value offset, wherein the value offset is associated with the actionable element of the interface.

13. The method of claim 12, wherein the variation between exchanging the second amount with the second transaction instrument for the offer and exchanging the first amount with the first transaction instrument for the offer is that the second amount is less than the first amount; and
wherein the content of the interface comprises a comparison of a ratio between the first amount and the second amount.

14. The method of claim 12, wherein the variation between exchanging the second amount with the second transaction instrument for the offer and exchanging the first amount with the first transaction instrument for the offer is that a return amount is transferred to the second transaction instrument subsequent to authorizing the transaction request; and
wherein the content of the interface comprises a comparison of the first amount and the variation between the second amount and the return amount.

15. The method of claim 11, wherein prior to authorizing the transaction request the method further comprises:
configuring the transaction request to correspond to the first amount for the offer, wherein configuring the transaction request comprises embedding the first amount in the transaction request; and
validating that the transaction request corresponds to the first amount and corresponds to the second transaction instrument, and wherein in response to the transaction request corresponding to the first amount and corresponding to the second transaction instrument, the transaction request is adjusted to correspond to the second amount, wherein adjusting the transaction request comprises removing the first amount from the transaction request and embedding the second amount in the transaction request.

16. The method of claim 11, wherein prior to authorizing the transaction request the method comprises:
configuring the transaction request to correspond to the second amount for the offer, wherein configuring the transaction request comprises embedding the second amount in the transaction request; and
validating that the transaction request corresponds to the second amount and corresponds to the first transaction instrument, and wherein in response to the transaction request corresponding to the second amount and corresponding to the first transaction instrument, the transaction request is adjusted to include the first amount instead of the second amount, wherein adjusting the transaction request comprises removing the second amount from the transaction request and embedding the first amount in the transaction request.

17. The method of claim 11, wherein in response to a selection of the actionable element, the method further comprises:
determining a transaction instrument element is at least one of the first transaction instrument or the second transaction instrument; and
updating the interface corresponding to the transaction instrument element, wherein the transaction instrument element corresponds to at least one of a first available amount corresponding to the first transaction instrument or a second available amount corresponding to the second transaction instrument, wherein the first available amount is a first maximum amount of the first transaction instrument available for the transaction request and the second available amount is a second maximum amount of the second transaction instrument available for the transaction request.

18. The method of claim 11, further comprising:
modeling the category with the offer to generate a third amount for the offer, wherein the third amount corresponds to a third transaction instrument;
updating the interface corresponding to the first amount and the second amount to also correspond to the third amount;
receiving, from the merchant computing system, the transaction request corresponding to at least one of the first transaction instrument, the second transaction instrument, or the third transaction instrument, wherein the transaction request comprises the transaction information associated with the offer; and
authorizing the transaction request for either the first amount, the second amount, or the third amount based on the transaction request corresponding to at least one of the first transaction instrument, the second transaction instrument, or the third transaction instrument.

19. A non-transitory computer-readable storage medium having instructions stored thereon that, when executed by at least one processing circuit, cause the processing circuit to perform operations comprising:
receiving, from a graphical user interface (GUI) presented on a user device, a request associated with an offer;
determining a category of the offer;
modeling the category with the offer to generate a first amount and a second amount for the offer, wherein the first amount corresponds to a first transaction instrument and the second amount corresponds to a second transaction instrument;
generating and providing, to the GUI of the user device, an interface corresponding to the first amount and the second amount, wherein the interface comprises an actionable element and content associated with the offer;
receiving, from a merchant computing system, a transaction request corresponding to at least one of the first transaction instrument or the second transaction instrument, wherein the transaction request comprises transaction information associated with the offer; and
authorizing the transaction request for either the first amount or the second amount based on the transaction request corresponding to at least one of the first transaction instrument or the second transaction instrument.

20. The non-transitory computer-readable storage medium of claim 19, wherein the operations further comprise:
identifying a variation between exchanging the second amount with the second transaction instrument for the offer and exchanging the first amount with the first transaction instrument for the offer;
modeling the variation between exchanging the second amount with the second transaction instrument for the offer and exchanging the first amount with the first transaction instrument for the offer to generate a value offset, wherein the value offset corresponds to exchanging the second amount with the second transaction instrument for the offer instead of exchanging the first amount with the first transaction instrument for the offer; and
updating the interface comprising the value offset, wherein the value offset is associated with the actionable element of the interface.
